(19) United States
(12) Patent Application Publication
(10) Pub. No.: US 2015/0268779 A1
(43) Pub. Date: Sep. 24, 2015

(54) TOUCH DISPLAY DEVICE

(71) Applicant: InnoLux Corporation, Jhu-Nan (TW)

(72) Inventors: Jenn-Fang YANG, Jhu-Nan (TW); Cheng-Hsia KUO, Jhu-Nan (TW); Wen-Kuen CHEN, Jhu-Nan (TW)

(21) Appl. No.: 14/660,420

(22) Filed: Mar. 17, 2015

(30) Foreign Application Priority Data
Mar. 18, 2014 (TW) 103110146

(51) Int. Cl. G06F 3/041; G06F 3/047

(52) U.S. Cl. CPC G06F 3/0412; G06F 3/047

(57) ABSTRACT

A touch display device includes a display panel and a touch electrode layer. The touch electrode layer is disposed on the display panel and has a touch area, a peripheral area and a plurality of electrodes. The electrodes are disposed in the touch area and at least divided into a first electrode group and a second electrode group. The peripheral area has a first sub-area corresponding to the first electrode group and a second sub-area corresponding to the second electrode group. A plurality of extended wires of the electrodes of the first electrode group are extended to the first sub-area from the touch area, and a plurality of extended wires of the electrodes of the second electrode group are extended to the second sub-area from the touch area.

### CROSS REFERENCE TO RELATED APPLICATIONS

This Non-provisional application claims priority under 35 U.S.C. §119(a) on Patent Application No(s). 103110146 filed in Taiwan, Republic of China on Mar. 18, 2014, the entire contents of which are hereby incorporated by reference.

### BACKGROUND OF THE INVENTION

1. Field of Invention

The invention relates to a touch display device.

2. Related Art

With the progress of technologies, various novel information devices are invented, such as cell phones, tablet computers, ultrabooks and GPS navigation apparatuses. Generally, a keyboard and mouse are commonly used to manipulate the information device for inputting information. Besides, the touch control technology currently also becomes a popular manipulation method for the information device and brings an intuitive operation. Accordingly, a touch display device using the touch control technology can provide a friendly and intuitive interface for the input operation, and therefore users of all ages can manipulate the touch display device by fingers or a stylus.

In general, the touch display device can be divided into two types, one is in-cell touch display device where a sensing electrode layer is disposed within the display panel (e.g. LCD panel), and the other one is out-cell touch display device where an additional touch panel including a sensing electrode layer is disposed on the display panel.

### SUMMARY OF THE INVENTION

An objective of the invention is to provide a touch display device which can be an in-cell, on-cell or out-cell touch display device.

To achieve the above objective, a touch display device according to the invention includes a display panel and a touch electrode layer. The touch electrode layer is disposed on the display panel and has a touch area, a peripheral area and a plurality of electrodes. The electrodes are disposed in the touch area and at least divided into a first electrode group and a second electrode group. The peripheral area has a first sub-area corresponding to the first electrode group and a second sub-area corresponding to the second electrode group. A plurality of extended wires of the electrodes of the first electrode group are extended to the first sub-area from the touch area, and a plurality of extended wires of the electrodes of the second electrode group are extended to the second sub-area from the touch area.

To achieve the above objective, a touch display device according to the invention comprises a display panel, a touch electrode layer, at least a layer-switching element and a circuit board. The touch electrode layer is disposed on the display panel and has a touch area, a peripheral area and a plurality of electrodes disposed in the touch area. The layer-switching element is disposed in the peripheral area. A plurality of extended wires of the electrodes are extended to the layer-switching element from the touch area and electrically connected to the layer-switching element. The circuit board is disposed adjacent to the touch electrode layer and electrically connected to the layer-switching element through a plurality of wires disposed in the peripheral area.

To achieve the above objective, a touch display device according to the invention comprises a display panel, a touch electrode layer, a circuit board and at least a layer-switching element. The touch electrode layer is disposed on the display panel and has a touch area, a peripheral area and a plurality of electrodes disposed in the touch area. The circuit board is disposed adjacent to the touch electrode layer. The layer-switching element is disposed in the peripheral area and includes a plurality of input ends and a plurality of output ends. The input ends are electrically connected to the electrodes, the output ends are electrically connected to the circuit board, and the number of the input ends is greater than that of the output ends.

As mentioned above, in the touch display device of the invention, the electrodes of the touch electrode layer are at least divided into a first electrode group and a second electrode group, and the extended wires of the electrodes of the first electrode group are extended to the corresponding first sub-area from the touch area and the extended wires of the electrodes of the second electrode group are extended to the corresponding second sub-area from the touch area. Or, at least one layer-switching element is disposed in the peripheral area, the extended wires of the electrodes are extended to the layer-switching element from the touch area and electrically connected to the layer-switching element, and the circuit board is electrically connected to the layer-switching element through the plural wires disposed in the peripheral area. Or, at least one layer-switching element is disposed in the peripheral area, the extended wires of the electrodes are extended to the layer-switching element from the touch area, and besides, the layer-switching element includes a plurality of input ends electrically connected to the electrodes and a plurality of output ends electrically connected to the circuit board, and the number of the input ends is greater than that of the output ends. Thereby, the touch display device of this invention is different from the conventional art and is a more favorable touch display device.

Moreover, in an embodiment, the touch display device of the invention not only can solve the problem of the bad touch sensing effect due to the larger impedance, but also can achieve the large-sized touch control requirement and the increased process yield by the simpler process. Besides, in another embodiment the touch display device of the invention not only can solve the problem of the bad touch sensing effect due to the larger impedance and reduce the process complexity, but also can use the layer switching design of the layer-switching element and less wires to reduce the bonding difficulty due to a lot of electrode connecting circuits.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of a touch display device;

FIG. 2 is a schematic diagram of a touch display device of an embodiment of the invention; and

FIGS. 3A to 3G are schematic diagrams of the touch display devices according to different embodiments of the invention.

### DETAILED DESCRIPTION OF THE INVENTION

The present invention will be apparent from the following detailed description, which proceeds with reference to the accompanying drawings, wherein the same references relate to the same elements.

To be noted, the all embodiments shown in the figures are just for the illustrative purpose but not for representing the actual dimensions.

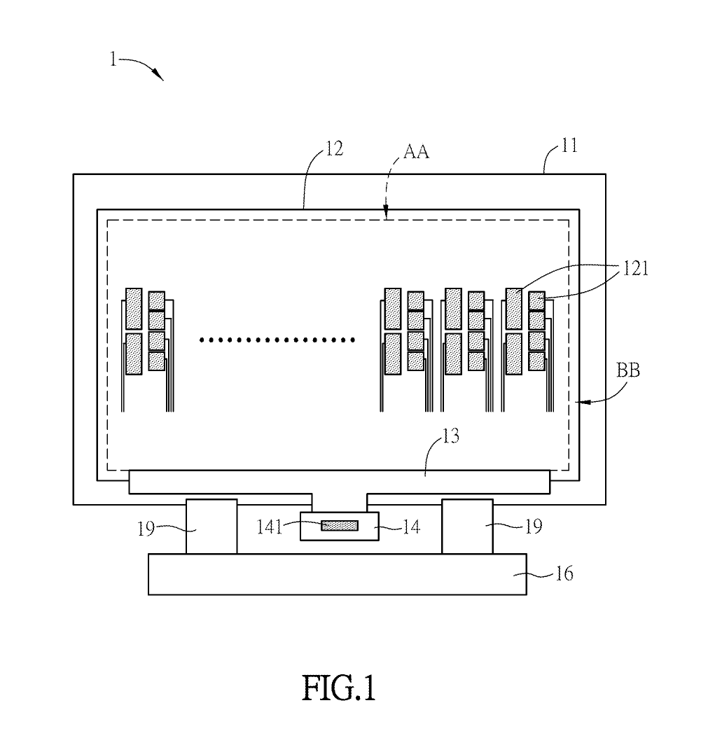

FIG. 1 is a schematic diagram of a touch display device 1 in an embodiment.

The touch display device 1 includes a display panel 11 and a touch electrode layer 12.

The touch electrode layer 12 is disposed on the display panel 11 and has a touch area AA, a peripheral area BB and a plurality of electrodes 121. The peripheral area BB is disposed on the outside of the touch area AA, and the electrodes 121 are disposed within the touch area AA. The electrodes 121 are the driving electrodes and sensing electrodes for the touch control (i.e. the so-called Tx and Rx, generally the transparent conductive electrodes, such as ITO). The touch position of the user can be obtained when the user touches the touch area AA.

The touch display device 1 can further include a circuit board 14 and a control circuit board 16. The circuit board 14 is disposed adjacent to the touch electrode layer 12 and electrically connected to the electrodes 121 of the touch electrode layer 12 by a flexible cable 13. Herein, the circuit board 14 is the control circuit board for the touch control, and can have, for example, a processing element 141, such as a microcontroller unit (MCU), for driving the electrodes 121 and processing the touch signal. The control circuit board 16 includes the control circuit and elements for driving and controlling the display panel 11. The control circuit board 16 of this embodiment is electrically connected to the display panel 11 by two connecting circuit boards 19. The operation of the display panel 11 can be driven and controlled by the control circuit board 16. The flexible cable 13 can be a flexible printed circuit (FPC) or COF (chip on film) and the connecting circuit board 19 also can be an FPC or COF, for example.

When the structure of the touch display device 1 is applied to a large-sized touch display device, the electrode length of the electrodes 121 (i.e. sensing elements) will be increased. Therefore, the impedance of the electrodes 121 will become too large, and it disadvantages the feed in and reception of the touch signal. Moreover, since the impedance of the electrodes 121 is larger, there is a need to introduce other materials, processes or designs, such as metal bridge or metal trace, into the touch display device 1, and therefore the number of the photomask will be increased and the process will become complicated. Besides, due to the more circuits connecting the electrodes 121 to the circuit board 14, the bonding difficulty is increased and the yield will be reduced.

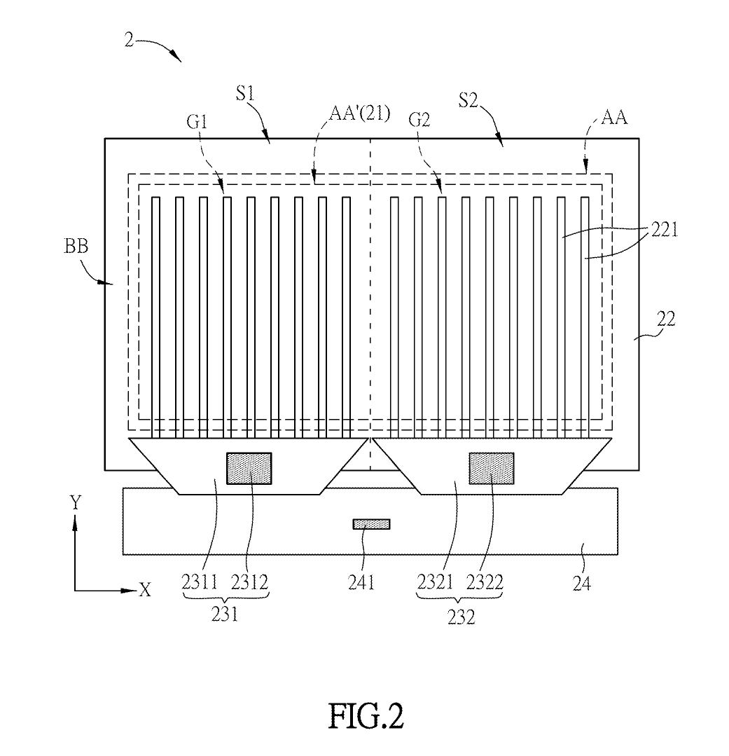

Refer to FIG. 2, therefore, which is a schematic diagram of a touch display device 2 of an embodiment of the invention.

The touch display device 2 is, for example but not limited to, a tablet computer, a smart phone, a GPS navigation apparatus, a notebook computer or an electronic device including a touch screen. Moreover, the horizontal direction of the touch display device 2 in FIG. 2 is defined as a first direction X and the perpendicular direction is defined as a second direction Y, and the first direction X is perpendicular to the second direction Y.

The touch display device 2 includes a display panel 21 and a touch electrode layer 22.

The display panel 21 can be an LCD panel or an OLED display panel. Herein for example, the display panel 21 is an LCD panel and has a display area AA′. The display panel 21 includes a first substrate, a second substrate and a liquid crystal layer (not shown) disposed between the first and second substrates. The first and second substrates are made by transparent material, and each of them can be a glass substrate, a quartz substrate or a plastic substrate. Besides, the first substrate can be a thin film transistor substrate while the second substrate can be a color filter substrate. However, in other embodiments, the black matrix of the color filter substrate can be removed to the thin film transistor substrate, so that the first substrate becomes a BOA (BM on array) substrate, or the color filter layer can be disposed on the thin film transistor substrate, so that the first substrate becomes a COA (color filter on array) substrate. To be noted, this invention is not limited thereto.

The touch electrode layer 22 is disposed on the display panel 21 and has a touch area AA, a peripheral area BB and a plurality of electrodes 221. The peripheral area BB is disposed on the outside of the touch area AA and the electrodes 221 are disposed within the touch area AA. The material of the electrodes 221 is ITO for example, and the electrodes 221 can be at least divided into a first electrode group G1 and a second electrode group G2. In this embodiment, the electrodes 221 are divided into the left and right groups, i.e. the first electrode group G1 and the second electrode group G2, by the second direction Y (perpendicular to the first direction X). The electrodes 221 include the driving electrodes and sensing electrodes for the touch control (i.e. the so-called Tx and Rx, not shown). The touch position of the user can be obtained when the user touches the touch area AA.

The electrodes 221 (the driving electrodes Tx and the sensing electrodes Rx) can be disposed on the same layer (i.e. coplanarly) or on different layers. The electrodes 221 can be disposed on a substrate, which can be a substrate (such as a cover plate) additionally disposed on the display panel 21 so that the touch display device 2 can become an out-cell touch display device (e.g. in one glass solution, OGS). Otherwise, the substrate can be the second substrate (such as the color filter substrate) of the display panel 21 so that the touch display device 2 can become an on-cell or in-cell touch display device. However, this invention is not limited thereto. The electrodes 221 also can be disposed on the same side of the substrate (such as single-sided ITO, SITO) or on the opposite sides of the substrate (such as double-sided ITO, DITO).

The peripheral area BB includes a first sub-area S1 corresponding to the first electrode group G1 and a second sub-area S2 corresponding to the second electrode group G2. Besides, the extended wires of the electrodes 221 of the first electrode group G1 are extended to the first sub-area S1 from the touch area AA, and the extended wires of the electrodes 221 of the second electrode group G2 are extended to the second sub-area S2 from the touch area AA. In other embodiments, however, if the electrodes 221 are divided into three or four groups or more electrode groups, the peripheral area BB will correspondingly include the sub-areas in the number corresponding to the electrode groups (for example, four electrode groups are corresponding to four sub-areas, etc.).

In this embodiment, the touch display device 2 can further include a circuit board 24 and at least a layer-switching element. The circuit board 24 is disposed adjacent to the touch electrode layer 22. Herein, the circuit board 24 is the control circuit board (e.g. PCBA) for the touch control, which can include a processing element 241 for driving the electrodes 221 and processing the touch signal. Herein, the processing element 241 is a microcontroller unit (MCU). The layer-switching element is connected to the peripheral area BB and at least includes a first layer-switching element 231 and a second layer-switching element 232. The first layer-switching element 231 is disposed in the first sub-area S1 and the second layer-switching element 232 is disposed in the second sub-area S2. The first layer-switching element 231 is physically and electrically connected with the first sub-area S1 and the circuit board 24, and the second layer-switching element 232 is physically and electrically connected with the second sub-area S2 and the circuit board 24. The first layer-switching element 231 or the second layer-switching element 232 can be a chip (i.e. IC), or a carrier and a chip (i.e. IC) disposed on the carrier, or an FPC. In this embodiment, the first layer-switching element 231 includes a carrier 2311 and a chip 2312 and the second layer-switching element 232 includes a carrier 2321 and a chip 2322, for example. The chips 2312, 2322 are electrically connected to the processing element 241 and can be a layer-switching IC or a touch control IC (the touch control IC has the function of the layer-switching IC) for example. The carriers 2311, 2321 are films for example, so that the first layer-switching element 231 and the second layer-switching element 232 are COFs. The chips 2312, 2322 of this embodiment are touch control ICs for example.

Accordingly, in this embodiment, the electrodes 221 of the touch electrode layer 22 are divided into groups and the corresponding layer-switching elements 231, 232 are electrically connected to the circuit board 24. Therefore, the problem that the touch sensing effect is bad due to the larger impedance will be solved, and the large-sized touch control requirement and the increased process yield can be achieved by the simpler process.

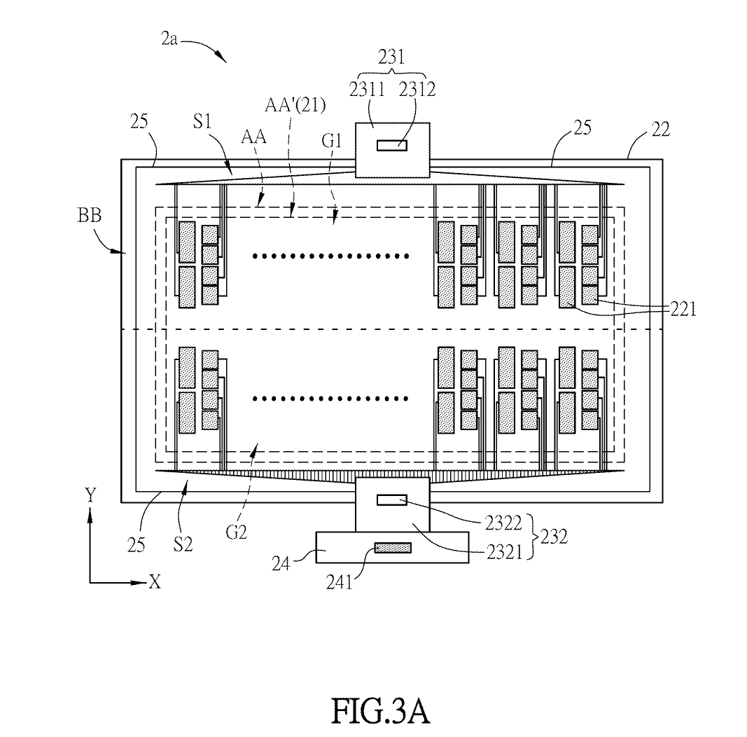

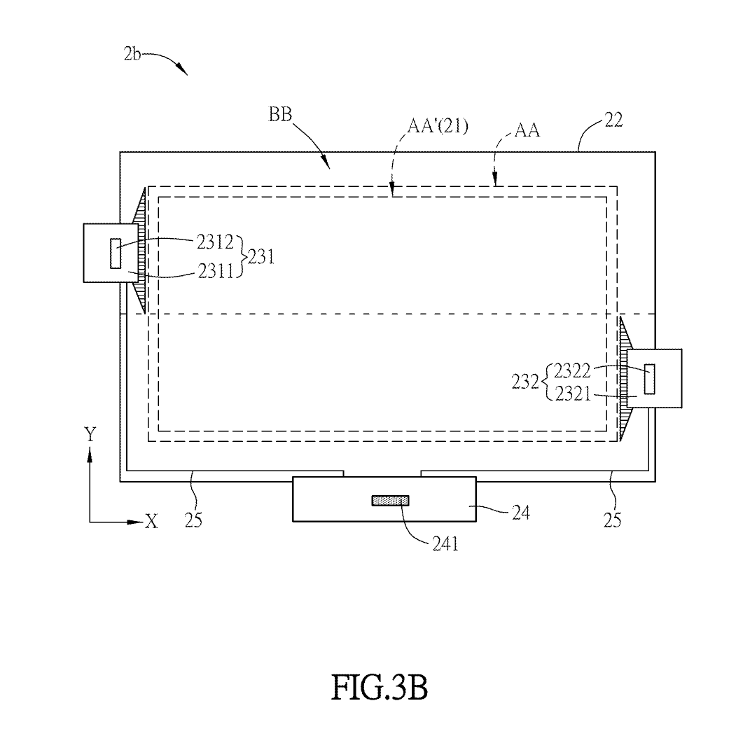

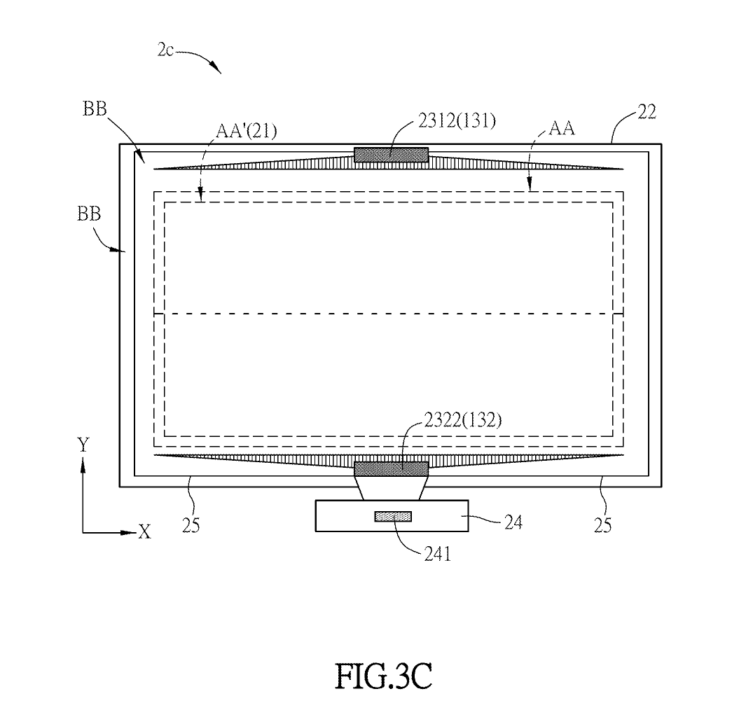

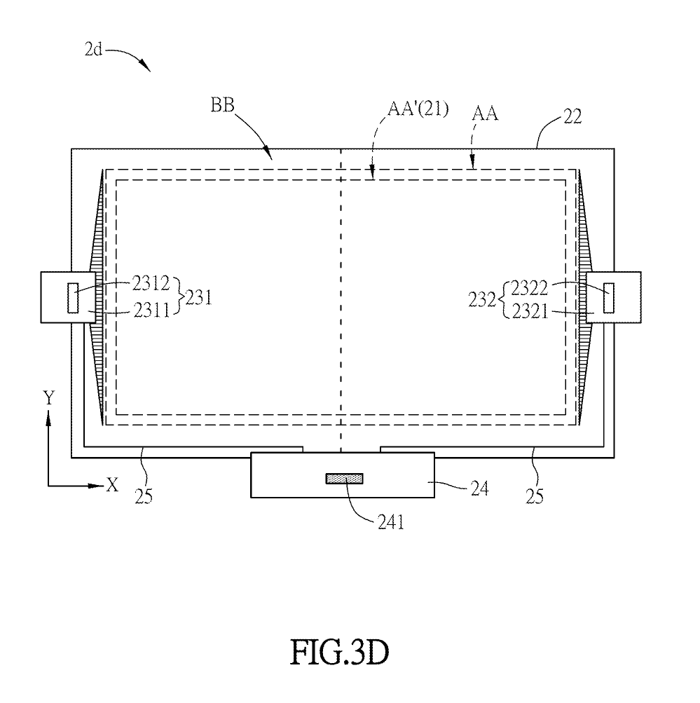

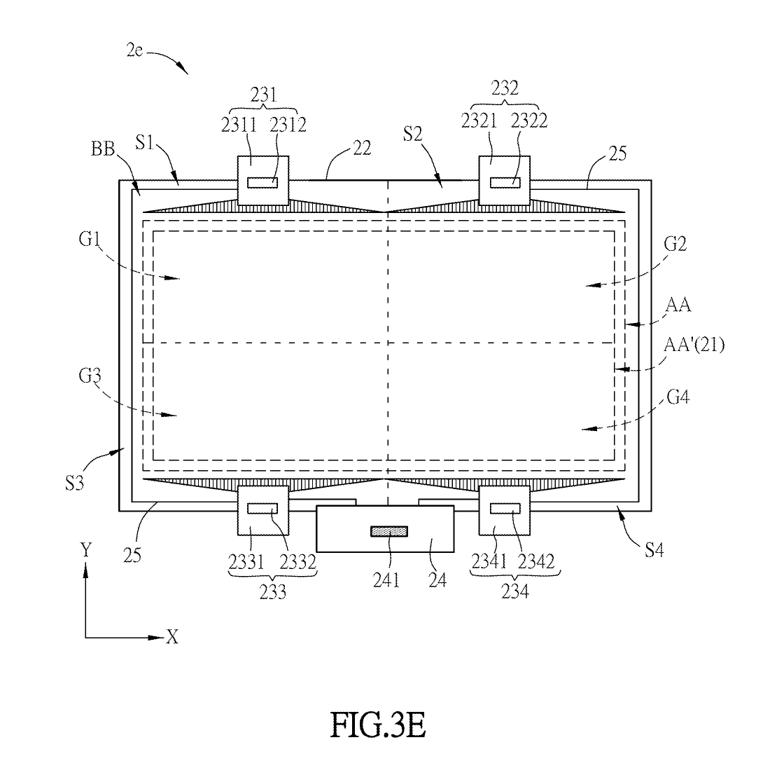

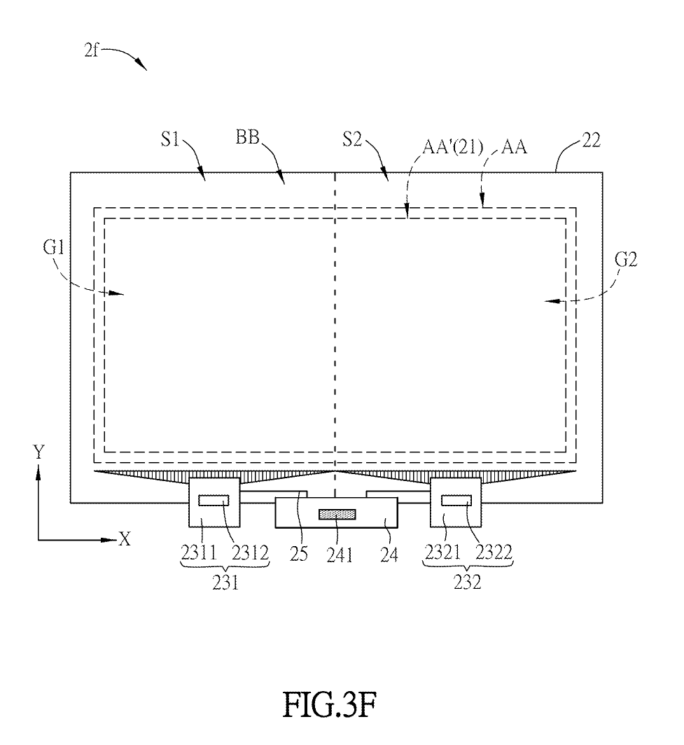

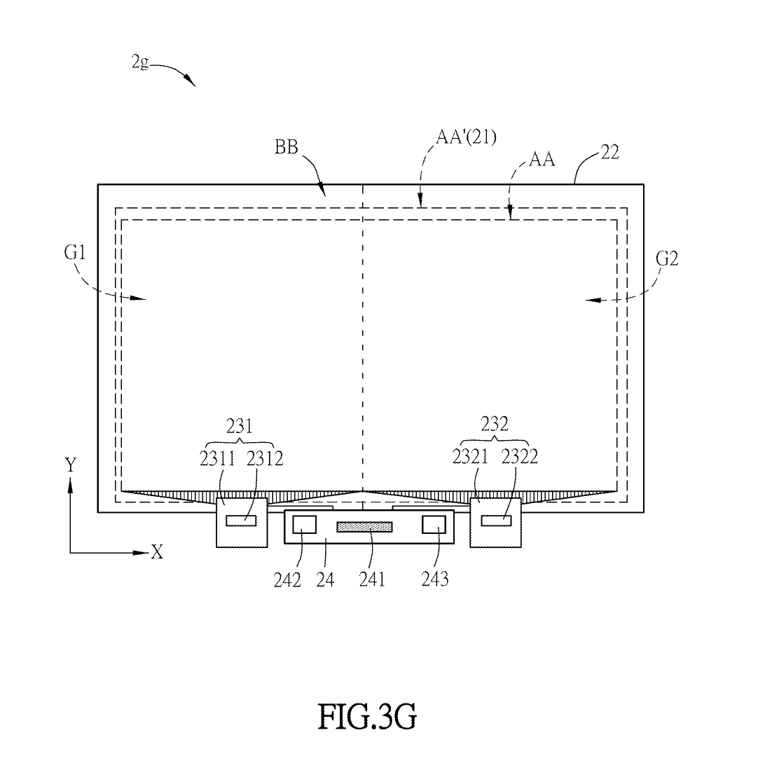

FIGS. 3A to 3G are schematic diagrams of the touch display devices 2a-2g according to different embodiments of the invention. The electrodes 221 are not shown in FIGS. 3B to 3G.

As shown in FIG. 3A, the touch display device 2a is the same as the touch display device 2, including the display panel 21, the touch electrode layer 22, the layer-switching element (including the first and second layer-switching elements 231 and 232) and the circuit board 24. Moreover, the electrodes 221 of the touch display device 2a are also divided into the first electrode group G1 and the second electrode group G2, and the touch display device 2a also has the first sub-area S1 and the second sub-area S2 correspondingly.

However, the difference from the touch display device 2 is that the electrodes 221 of the touch display device 2a are divided into the upper-side first electrode group G1 and the lower-side second electrode group G2 by the first direction X (i.e. the horizontal direction in FIG. 3A), so that the first sub-area S1 is the upper portion of the peripheral area BB and the second sub-area S2 is the lower portion of the peripheral area BB. Moreover, since the first layer-switching element 231 and the circuit board 24 are disposed on the upper side and lower side of the touch electrode layer 22, respectively, the first layer-switching element 231 can be electrically connected with the second layer-switching element 232 through a plurality of wires 25 disposed in the peripheral area BB and then electrically connected to the circuit board 24 through the second layer-switching element 232. The wires 25 can be disposed in the peripheral area BB on the left and right sides of the touch electrode layer 22, but also can be disposed in the peripheral area BB on the single side of the touch electrode layer 22. In this embodiment, the wires 25 are disposed in the peripheral area BB on the left and right sides of the touch electrode layer 22 for example. To be noted, only one wire 25 is shown in FIG. 3A but it can represent plural wires.

Since a large-sized touch display device includes a lot of driving electrodes Tx and sensing electrodes Rx, the connecting circuits connecting the electrodes to the first layer-switching element 231 and the second layer-switching element 232 have a large number and therefore the first layer-switching element 231 and the second layer-switching element 232 have a lot of input ends (can be called the first input ends and the second input ends). Nevertheless, the output ends (can be called the first output ends and the second output ends) of the first layer-switching element 231 and the second layer-switching element 232 will be reduced in number by grouping the input ends with the same level (i.e. short-circuit connection), and therefore the number of the output ends will be far less than that of the input ends. For example, if the touch electrode layer 22 has 63 driving electrodes Tx and 18 sensing electrodes Rx, there will be 2268 (63*18) electrode wires connecting to the input ends of the first and second layer-switching elements 231 and 232, but each of the first and second layer-switching elements 231 and 232 of this embodiment just has 81 (63+18) output ends, so that 81 wires 25 are required to connect to the first layer-switching element 231. Therefore, this embodiment not only can solve the problem of the bad touch sensing effect due to the larger impedance and reduce the process complexity, but also can use the layer switching design of the layer-switching element and less wires to reduce the bonding difficulty due to a lot of electrode connecting circuits.

As shown in FIG. 3B, the main difference between the touch display devices 2b and 2a is that the first layer-switching element 231 and the second layer-switching element 232 of the touch display device 2b are disposed on the upper left side and the lower right side of the touch electrode layer 22, respectively, although they are disposed on the opposite sides of the touch electrode layer 22 like the touch display device 2a. Moreover, the first layer-switching element 231 and the second layer-switching element 232 are electrically connected to the circuit board 24 through the wires 25.

Since other technical features of the touch display devices 2a, 2b can be comprehended by referring to the touch display device 2, their descriptions are omitted here for conciseness.

As shown in FIG. 3C, the main difference between the touch display devices 2c and 2a is that the first and second layer-switching elements 131 and 132 of the touch display device 2c are chips 2312 and 2322 and disposed on an inflexible substrate (i.e. chip on glass, COG). Herein, the inflexible substrate can be a cover plate disposed on the display panel 21 or can be the second substrate (color filter substrate) of the display panel 21. However, this invention is not limited thereto.

As shown in FIG. 3D, the main difference between the touch display devices 2d and 2a is that the electrodes 221 of the touch electrode layer 22 of the touch display device 2d are divided into the left and right groups by the second direction Y, and the first and second layer-switching elements 231 and 232 are disposed at the central portions of the left and right sides of the touch electrode layer 22, respectively, and electrically connected to the circuit board 24 through the wires 25.

As shown in FIG. 3E, the main difference between the touch display devices 2e and 2a is that the electrodes 221 of the touch electrode layer 22 of the touch display device 2e are divided into four groups, the first electrode group G1 to the fourth electrode group G4, by the first direction X and the second direction Y, the peripheral area BB also has the first sub-area S1 to the fourth sub-area S4 corresponding to the first electrode group G1 to the fourth electrode group G4, and the first layer-switching element 131 to the fourth layer-switching element 134 are correspondingly disposed in the first sub-area Si to the fourth sub-area S4. Therefore, the first layer-switching element 231 is electrically connected to the circuit board 24 through the wires 25 and the third layer-switching element 233, and the second layer-switching element 232 is electrically connected to the circuit board 24 through the wires 25 and the fourth layer-switching element 234.

As shown in FIG. 3F, the main difference between the touch display devices 2f and 2a is that the electrodes 221 of the touch electrode layer 22 of the touch display device 2f are divided into the first and second electrode groups G1 and G2 by the second direction Y, and the first and second layer-switching elements 231 and 232 are disposed on the same side of the touch electrode layer 22 and disposed at the central portions of the lower left and lower right sides of the touch electrode layer 22 respectively. Besides, the first and second layer-switching elements 231 and 232 are disposed adjacent to the circuit board 24.

Since other technical features of the touch display devices 2c-2f can be comprehended by referring to the touch display device 2a, their descriptions are omitted here for conciseness.

To be noted, in other embodiments, the touch display device 2f can further include a control circuit board (not shown), which is disposed adjacent to the display panel 21 and electrically connected to the display panel 21. The control circuit board includes the control circuit and elements for driving and controlling the display panel 21. The control circuit board also can be electrically connected to the display panel 21 through two connecting circuit boards (such as flexible circuit boards, not shown). The operation of the display panel 21 can be driven and controlled by the control circuit board. In other embodiments, the circuit board 24 also can include an A/D converter (not shown) to convert the analog touch signal into the digital signal that can be processed by the digital processing element 241. Moreover, in another embodiment, the circuit board 24 and the control circuit board of the display panel can be integrated together to become a system circuit board (not shown) for saving the process cost.

As shown in FIG. 3G, the main difference between the touch display devices 2g and 2f is that the chip 2312 of the first layer-switching element 231 and the chip 2322 of the second layer-switching element 232 of the touch display device 2g are not touch control ICs but the layer-switching ICs (just converting a large number of input ends to less number of output ends). Moreover, the circuit board 24 of the touch display device 2g further includes two chips 242, 243, which are touch control ICs and electrically connected to the chips 2312, 2322, respectively, for processing the touch signal.

Since other technical features of the touch display device 2g can be comprehended by referring to the touch display device 2f, their descriptions are omitted here for conciseness.

Summarily, in the touch display device of the invention, the electrodes of the touch electrode layer are at least divided into a first electrode group and a second electrode group, and the extended wires of the electrodes of the first electrode group are extended to the corresponding first sub-area from the touch area and the extended wires of the electrodes of the second electrode group are extended to the corresponding second sub-area from the touch area. Or, the layer-switching element is disposed in the peripheral area, the extended wires of the electrodes are extended to the layer-switching element from the touch area and electrically connected to the layer-switching element, and the circuit board is electrically connected to the layer-switching element through the plural wires disposed in the peripheral area. Or, the layer-switching element is disposed in the peripheral area, the extended wires of the electrodes are extended to the layer-switching element from the touch area, and besides, the layer-switching element includes a plurality of input ends electrically connected to the electrodes and a plurality of output ends electrically connected to the circuit board, and the number of the input ends is greater than that of the output ends. Thereby, the touch display device of this invention is different from the conventional art and is a more favorable touch display device.

Moreover, in an embodiment, the touch display device of the invention not only can solve the problem of the bad touch sensing effect due to the larger impedance, but also can achieve the large-sized touch control requirement and the increased process yield by the simpler process. Besides, in another embodiment the touch display device of the invention not only can solve the problem of the bad touch sensing effect due to the larger impedance and reduce the process complexity, but also can use the layer switching design of the layer-switching element and less wires to reduce the bonding difficulty due to a lot of electrode connecting circuits.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A touch display device, comprising:
a display panel; and
a touch electrode layer disposed on the display panel and having a touch area, a peripheral area and a plurality of electrodes, wherein the electrodes are disposed in the touch area and at least divided into a first electrode group and a second electrode group, the peripheral area has a first sub-area corresponding to the first electrode group and a second sub-area corresponding to the second electrode group, a plurality of extended wires of the electrodes of the first electrode group are extended to the first sub-area from the touch area, and a plurality of extended wires of the electrodes of the second electrode group are extended to the second sub-area from the touch area.

2. The touch display device as recited in claim 1, further comprising:
a circuit board disposed adjacent to the touch electrode layer; and
at least a first layer-switching element and a second layer-switching element, wherein the first layer-switching element is disposed in the first sub-area, the second layer-switching element is disposed in the second sub-area, the first layer-switching element is electrically connected with the first electrode group and the circuit board, and the second layer-switching element is electrically connected with the second electrode group and the circuit board.

3. The touch display device as recited in claim 2, wherein the first layer-switching element or the second layer-switching element is electrically connected to the circuit board through a plurality of wires disposed in the peripheral area.

4. The touch display device as recited in claim 3, wherein the first layer-switching element or the second layer-switching element is a chip, or a carrier and a chip disposed on the carrier, or an FPC.

5. The touch display device as recited in claim 3, wherein the first layer-switching element includes a plurality of first input ends and a plurality of first output ends, the first input ends are electrically connected to the first electrode group, the first output ends are electrically connected to the circuit board through the wires, and the number of the first input ends is greater than that of the first output ends.

6. The touch display device as recited in claim 3, wherein the second layer-switching element includes a plurality of second input ends and a plurality of second output ends, the second input ends are electrically connected to the second electrode group, the second output ends are electrically connected to the circuit board through the wires, and the number of the second input ends is greater than that of the second output ends.

7. A touch display device, comprising:
a display panel;
a touch electrode layer disposed on the display panel and having a touch area, a peripheral area and a plurality of electrodes disposed in the touch area;
at least a layer-switching element disposed in the peripheral area, wherein a plurality of extended wires of the electrodes are extended to the layer-switching element from the touch area and electrically connected to the layer-switching element; and
a circuit board disposed adjacent to the touch electrode layer and electrically connected to the layer-switching element through a plurality of wires disposed in the peripheral area.

8. The touch display device as recited in claim 7, wherein the electrodes are at least divided into a first electrode group and a second electrode group, the peripheral area has a first sub-area corresponding to the first electrode group and a second sub-area corresponding to the second electrode group, the extended wires of the electrodes of the first electrode group are extended to the first sub-area from the touch area, and the extended wires of the electrodes of the second electrode group are extended to the second sub-area from the touch area.

9. The touch display device as recited in claim 8, wherein the layer-switching element at least includes a first layer-switching element and a second layer-switching element, the first layer-switching element is disposed in the first sub-area and electrically connected to the first electrode group, the second layer-switching element is disposed in the second sub-area and electrically connected to the second electrode group, and the first layer-switching element or the second layer-switching element is electrically connected with the circuit board through the wires.

10. The touch display device as recited in claim 9, wherein the first layer-switching element or the second layer-switching element is a chip, or a carrier and a chip disposed on the carrier, or an FPC.

11. The touch display device as recited in claim 10, wherein the circuit board includes a processing element and the chip is electrically connected to the processing element.

12. The touch display device as recited in claim 9, wherein the first layer-switching element includes a plurality of first input ends and a plurality of first output ends, the first input ends are electrically connected to the first electrode group, the first output ends are electrically connected to the circuit board through the wires, and the number of the first input ends is greater than that of the first output ends.

13. The touch display device as recited in claim 9, wherein the second layer-switching element includes a plurality of second input ends and a plurality of second output ends, the second input ends are electrically connected to the second electrode group, the second output ends are electrically connected to the circuit board through the wires, and the number of the second input ends is greater than that of the second output ends.

14. A touch display device, comprising:
a display panel;
a touch electrode layer disposed on the display panel and having a touch area, a peripheral area and a plurality of electrodes disposed in the touch area;
a circuit board disposed adjacent to the touch electrode layer; and
at least a layer-switching element disposed in the peripheral area and including a plurality of input ends and a plurality of output ends, the input ends are electrically connected to the electrodes, the output ends are electrically connected to the circuit board, and the number of the input ends is greater than that of the output ends.

15. The touch display device as recited in claim 14, wherein the output ends are electrically connected to the circuit board through a plurality of wires disposed in the peripheral area.

16. The touch display device as recited in claim 15, wherein the electrodes are at least divided into a first electrode group and a second electrode group, the peripheral area has a first sub-area corresponding to the first electrode group and a second sub-area corresponding to the second electrode group, a plurality of extended wires of the electrodes of the first electrode group are extended to the first sub-area from the touch area, and a plurality of extended wires of the electrodes of the second electrode group are extended to the second sub-area from the touch area.

17. The touch display device as recited in claim 16, wherein the layer-switching element at least includes a first layer-switching element and a second layer-switching element, the first layer-switching element is disposed in the first sub-area and electrically connected to the first electrode group, the second layer-switching element is disposed in the second sub-area and electrically connected to the second electrode group, the output ends of the first layer-switching element or second layer-switching element are electrically connected to the circuit board through the wires.

18. The touch display device as recited in claim 17, wherein the first layer-switching element or the second layer-switching element is a chip, or a carrier and a chip disposed on the carrier, or an FPC.

19. The touch display device as recited in claim 18, wherein the circuit board includes a processing element and the chip is electrically connected to the processing element.

20. The touch display device as recited in claim 17, wherein the first layer-switching element and the second layer-switching element are disposed on the same side or opposite sides of the touch electrode layer.
